(19) United States
(12) Patent Application Publication
(10) Pub. No.: US 2024/0013374 A1
(43) Pub. Date: Jan. 11, 2024

(54) MULTI-STREAM LATE FUSION OF IMAGES FOR SEMANTIC SEGMENTATION

(71) Applicant: Palo Alto Research Center Incorporated, Palo Alto, CA (US)

(72) Inventor: Robert R. Price, Palo Alto, CA (US)

(73) Assignee: Palo Alto Research Center Incorporated, Palo Alto, CA (US)

(21) Appl. No.: 17/860,815

(22) Filed: Jul. 8, 2022

(51) Int. Cl. G06T 7/00; G06T 7/11

(52) U.S. Cl. CPC G06T 7/0012; G06T 7/11; G06T 2207/30096; G06T 2207/20084; G06T 2207/10032; G06T 2207/10132

(57) ABSTRACT

A method and system are provided for an improved semantic segmentation using a multi-stream late fusion using pretrained encoders to encode disparate channels independently while also integrating selected image features at a more abstract level in order to provide improved localization and image classification.

### BACKGROUND

Segmentation of images is a tool used in a variety of fields. For example, there is an extensive literature on segmentation of cancer lesions in both X-ray and ultrasound images. Recently, a new generation of ultrasound technology has been developed that takes advantage of the optoacoustic effect, i.e., optoacoustic imaging. In one form, it uses laser illumination to highlight the presence of hemoglobin molecules in the tissue. The hemoglobin response can be used to determine the oxygenation of the tissue surrounding tumors. Cancerous tumors tend to disrupt local vascular networks whereas benign tumors do not. This results in cancerous tumors having deoxygenated peripheries. There has been work on trying to produce segmented images using the optoacoustic features primarily using UNet networks. Prior art has used U-nets on single channel optoacoustic images (OA), or naively combined multiple OA channels at the input.

Further, there have been many applications of deep networks to optoacoustic data. Deep neural networks have been used to remove artifacts from optoacoustic images. Neda Davoudi, Xosé Luis Deán-Ben1,3 and Daniel Razansky, Deep learning optoacoustic tomography with sparse data. Nature Machine Intelligence. Vol 1, October 2019, pp 453-460. Deep neural networks have been used to classify level of oxygenation in tissue. C. Yang and F. Gao, “Eda-net: Dense aggregation of deep and shallow information achieves quantitative photoacoustic blood oxygenation imaging deep in human breast,” in International Conference on Medical Image Computing and Computer-Assisted Intervention, 246-254, Springer (2019), C. Yang, H. Lan, H. Zhong, et al., “Quantitative photoacoustic blood oxygenation imaging using deep residual and recurrent neural network,” in 2019 IEEE 16th International Symposium on Biomedical Imaging (ISBI 2019), 741-744, IEEE (2019), G. P. Luke, K. Hoffer-Hawlik, A. C. Van Namen,et al., “O-Net: A Convolutional Neural Network for Quantitative Photoacoustic Image Segmentation and Oximetry,”arXiv preprintarXiv:1911.01935 (2019), K. Hoffer-Hawlik and G. P. Luke, “abso2luteu-net: Tissue oxygenation calculation using photo acoustic imaging and convolutional neural networks,” (2019)]. Tissue classification has been done by traditional feature design with SVM and random forest classifiers. S. Moustakidis, M. Omar, J. Aguirre, et al., “Fully automated identification of skin morphology in raster-scan optoacoustic mesoscopy using artificial intelligence,” Medical Physics 46(9), 4046-4056 (2019). Publisher: Wiley Online Library. Lafci applies a generic UNet architecture to this problem. Berkan Lafci, Elena Mercep, Stefan Morscher, Xosé Luis. Deep Learning for Automatic Segmentation of Hybrid Optoacoustic Ultrasound (OPUS) Images, IEEE TRANSACTIONS ON ULTRASONICS, FERROELECTRICS, AND FREQUENCY CONTROL, VOL. 68, NO. 3, MARCH 2021, B. Lafci, E. Mercep, S. Morscher, et al., “Efficient segmentation of multi-modal optoacoustic and ultrasound images using convolutional neural networks,” in Photons Plus Ultrasound: Imaging and Sensing 2020, 11240, 112402N, International Society for Optics and Photonics (2020). Luke uses two U-Nets to segment blood vessels and the second estimates SO2 concentration. G. P. Luke, K. Hoffer-Hawlik, A. C. Van Namen, et al., “O-Net: A Convolutional Neural Network for Quantitative Photoacoustic Image Segmentation and Oximetry,”arXiv preprintarXiv:1911.01935 (2019). Grohl employs UNet and fully connected networks (FCNN). Janek Gröhl, Melanie Schellenberg, Kris Dreher, Niklas Holzwarth, Minu D. Tizabi, Alexander Seitel, and Lena Maier-Hein, Semantic segmentation of multispectral photoacoustic images using deep learning, https://arxiv.org/pdf/2105.09624.pdf. Jnawali explores use of 3D convolution to get blood volume concentration in samples of thyroid. K. Jnawali, B. Chinni, V. Dogra, et al., “Deep 3D convolutional neural network for automatic cancer tissue detection using multispectral photoacoustic imaging,” in Medical Imaging 2019:Ultrasonic Imaging and Tomography, 10955, 109551D, International Society for Optics and Photonics (2019), K. Jnawali, B. Chinni, V. Dogra, et al., “Transfer learning for automatic cancer tissue detection using multispectral photoacoustic imaging,” in Medical Imaging 2019: Computer-AidedDiagnosis, 10950, 109503W, International Society for Optics and Photonics (2019), K. Jnawali, B. Chinni, V. Dogra, et al., “Automatic cancer tissue detection using multispectral photoacoustic imaging,” International Journal of Computer Assisted Radiology and Surgery15(2), 309-320 (2020). Publisher: Springer. Chlis weights opto-acoustic channel features at the input and then passes them through a UNET. Nikolaos-Kosmas Chlis, Angelos Karlas, Nikolina-Alexia Fasoul, Michael Kallmayer, Hans-Henning Eckstein, Fabian J. Theis, Vasilis Ntziachristos, CarstenMarr, A sparse deep learning approach for automatic segmentation of human vasculature in multispectral optoacoustic tomography, Photoacoustics, Vol 20, December 2020. Yuan combines a fully connected network and a U-net on a single channel opto-acoustic image. Alan Yilun Yuan, Yang Gao, Liangliang Peng, Lingxiao Zhou, Jun Liu, Siwei Zhu, and Wei Song, Hybrid deep learning network for vascular segmentation in photoacoustic imaging, Biomed Opt Express November 1; 11(11): 6445-6457, 2020.

There is a deficiency in the field of any work combining traditional ultrasound (US) with optoacoustic (OA) features with deep networks. Naïve early combination prevents effective use of pretrained deep networks because the combined US-OA features do not look like natural image features. US features are very structural and OA features are volumetric and diffuse.

### BRIEF DESCRIPTION

According to one aspect of the presently described embodiments, the method for improved semantic segmentation in images comprises receiving image data from multiple channels corresponding to disparate input sources, splitting the image data into data streams, encoding the data streams using separate encoders to obtain encoded data at each stage of the separate encoders, concatenating the encoded data across each stage of the separate encoders, encoding the concatenated data for each stage of the encoders using a single layer of non-linear units to obtain a feature array, and outputting the feature array.

According to another aspect of the presently described embodiments, the disparate input sources comprise ultrasound and opto-acoustic input sources.

According to another aspect of the presently described embodiments, the disparate input sources comprise input sources using different sensors on different bands.

According to another aspect of the presently described embodiments, the method further comprises use of pretrained networks to accelerate learning.

According to another aspect of the presently described embodiments, the method further comprises decoding the feature array.

According to another aspect of the presently described embodiments, the images include images of cancer lesions.

According to another aspect of the presently described embodiments, the images include satellite images.

According to another aspect of the presently described embodiments, a system for improved semantic segmentation in images comprises at least one processor and at least one memory, having stored therein instructions, the memory and instructions being configured such that execution of the instructions by the processor cause the system to receive image data from multiple channels corresponding to disparate input sources, split the image data into data streams, encode the data streams using separate encoders to obtain encoded data at each stage of the separate encoders, concatenate the encoded data across each stage of the separate encoders, encode the concatenated data for each stage of the encoders using a single layer of non-linear units to obtain a feature array, and output the feature array.

According to another aspect of the presently described embodiments, the disparate input sources comprise ultrasound and opto-acoustic input sources.

According to another aspect of the presently described embodiments, the disparate input sources comprise input sources using different sensors on different bands.

According to another aspect of the presently described embodiments, the memory and instructions are further configured such that execution of the instructions by the processor cause the system to use pretrained networks to accelerate learning.

According to another aspect of the presently described embodiments, the memory and instructions are further configured such that execution of the instructions by the processor cause the system to decode the feature array.

According to another aspect of the presently described embodiments, the images include images of cancer lesions.

According to another aspect of the presently described embodiments, the images include satellite images.

### BRIEF DESCRIPTION OF THE DRAWINGS

FIG. 1 is a flowchart illustrating an example method according to the presently described embodiments;

FIG. 2 is a flow diagram of an example system according to the presently described embodiments;

FIG. 3 is a block diagram of an example system according to the presently described embodiments;

FIG. 4 is a representation of an architecture of an example generic U-net architecture;

FIG. 5 is a flow diagram of an example encoding and decoding of an image according to the presently described embodiments; and

FIG. 6 is a representation of example images according to the presently described embodiments.

### DETAILED DESCRIPTION

According to the presently described embodiments, a technique is provided to use data or features from disparate sources of input data, e.g., different data channels, to analyze image data to, for example, perform image segmentation. Such a method and/or system allows for advantageous and selective exploitation of features of the various channels or sources to improve the process and/or result.

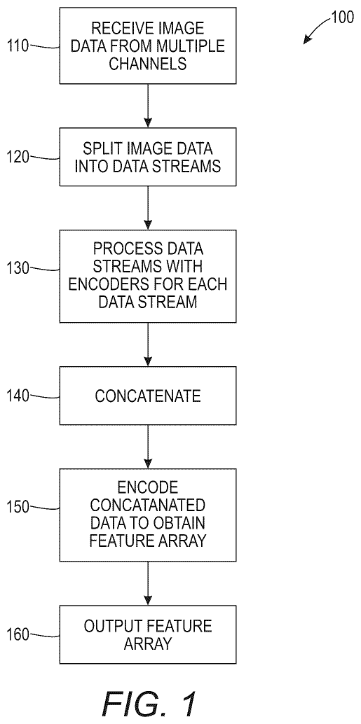

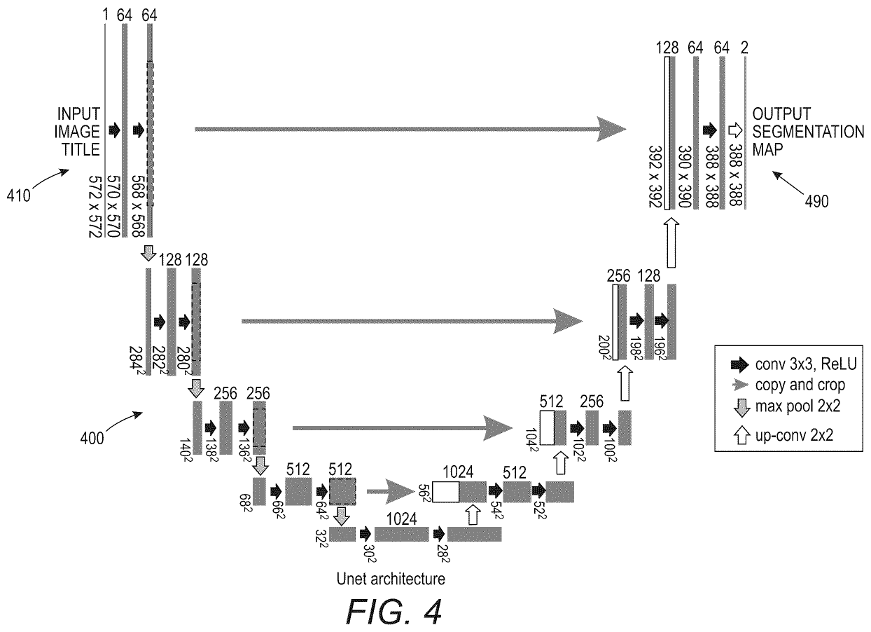

As will be appreciated by those of skill in the art, the presently described embodiments may be implemented in a variety of environments for a variety of different applications. As such, FIGS. 1-3 relate to a description of embodiments that can be applied to such a variety of different implementations. One application (to be described in more detail hereafter in connection with FIGS. 4-6) is directed to image segmentation relating to identification of cancer lesions. Other example implementations reside in other areas where uses of semantic segmentation utilize disparate sources of input data. One such example is satellite data analysis. In this example, satellite data analysts utilize data channels from different, disparate sensors, at times up to thirty (30) different bands. Of course, other implementations may also be realized.

With reference now to FIG. 1, a flowchart illustrating an example method 100 according to the presently described embodiments is illustrated. The method 100 may be implemented in a variety of systems (some of which will be described below). Initially, a system using the method 100 receives image data from multiple channels (at 110). It will be appreciated, as noted above, the multiple channels will, in at least one form, originate from disparate sources of input. The image data is then split into data streams (at 120). The data streams are processed with encoders for each data stream (at 130). The encoding can be accomplished in a variety of manners; however, in at least one form, the encoder makes use of convolutional neural network layers to abstract the image stage by stage from a detailed but shallow representation to a deep but coarse representation. As will be appreciated, this encodes many features describing the content or composition of the image. The result of the encoding, in at least one form, is encoded data at each stage of the separate encoders. Separate encoders for each data stream allow the system to better account for and/or address the disparate sources of input. Different modalities can have different kinds of structure. Several layers of computation might be required to group this structure together. Separate pipelines are used to extract structure from each modality. Taps off this pipeline allow the downstream decoder to make use of fused data at any level. Once encoded, the data is then concatenated across each stage of the separate encoders (at 140). The concatenated data is then encoded or re-sized for each stage of the encoders using a single layer of non-linear units to obtain a new feature array (at 150). In this regard, the encoding at this point could be, for example, a re-sizing of the data, if necessary or desired. The new feature array is an active combination of features for the multiple data streams. The new feature array is then output, stored or otherwise made available for use (at 160). For example, in at least one form, the feature array can be decoded to produce a semantic segmentation mask using any of a variety of decoding systems including, but not limited to, a Deep Lab decoder, a U-Net system, or others that will be apparent to those skilled in the art implementing the presently described embodiments.

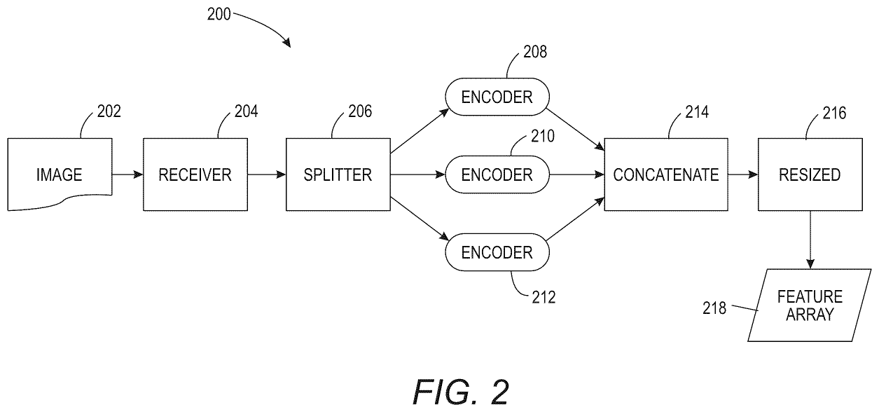

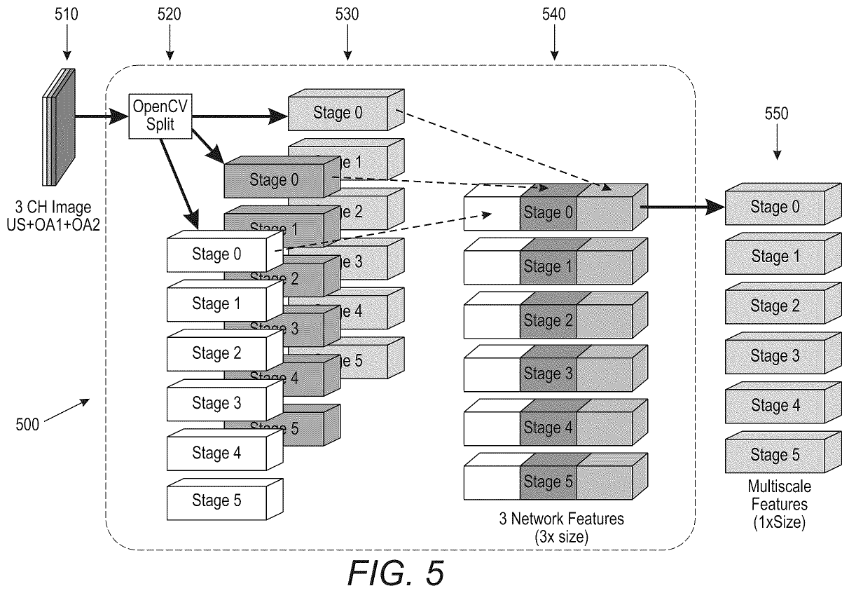

With reference to FIG. 2, a flow diagram of an example system 200 according to the presently described embodiments, e.g., to implement the method 100 of FIG. 1, is illustrated. As shown, an image 202 is received by a receiver 204. As noted, the image data is, in at least one form, received on multiple channels from disparate input sources. The receiver or input module 204 is connected to a splitter 206. The splitter 206 splits the image data into multiple data streams. The multiple data streams are then each encoded by an encoder, e.g., encoders 208, 210, and 212. It will be appreciated that multiple encoders may comprise the encoding system and each encoder functions to encode the data on a stage-by-stage basis, as referenced above. Once encoded, the image data is concatenated across each stage using an element 214 and, if necessary, subsequently processed at 216. At 216, the concatenated data is re-sized (if necessary) for each stage of the encoders using a single layer of non-linear units. In this regard, a projection is provided from a larger space down to a smaller space to allow an existing decoder to work on the new input. It should be appreciated that, as more specifically shown in the example FIG. 5, this split is done at multiple granularities in the image processing pipeline so that the downstream decoder can get information from multiple image scales. As a result, a new feature array 218 is generated by the system 200. As discussed above, for example, in at least one form, the feature array can be decoded to produce a semantic segmentation mask using any of a variety of decoding systems including, but not limited to, a Deep Lab decoder, a U-Net system, or others that will be apparent to those skilled in the art implementing the presently described embodiments.

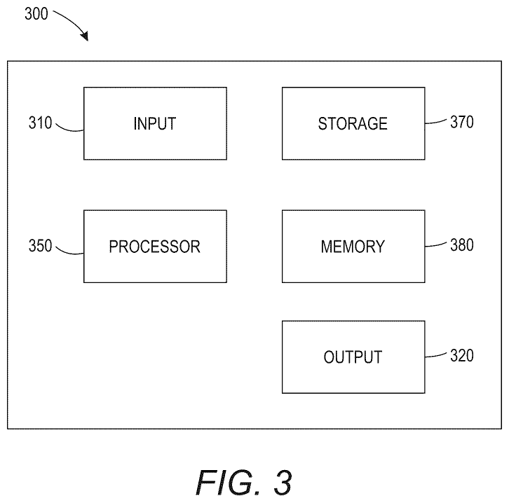

With reference now to FIG. 3, the above-described method 100 and other methods according to the presently described embodiments, as well as suitable architecture such as system components useful to implement the system 200 shown in FIG. 2 and in connection with other embodiments described herein (such as those described, for example, in connection with FIGS. 4-6), can be implemented on a computer using well-known computer processors, memory units, storage devices, computer software, and other components. A high-level block diagram of such a computer is illustrated in FIG. 3. Computer 300 contains at least one processor 350, which controls the overall operation of the computer 300 by executing computer program instructions which define such operation. The computer program instructions may be stored in at least one storage device or memory 380 (e.g., a magnetic disk or any other suitable non-transitory computer readable medium or memory device) and loaded into another memory 380 (e.g., a magnetic disk or any other suitable non-transitory computer readable medium or memory device), or another segment of memory 370, when execution of the computer program instructions is desired. Thus, the steps of the methods described herein (such as method 100 of FIG. 1) may be defined by the computer program instructions stored in the memory 380 and controlled by the processor 350 executing the computer program instructions. The computer 300 may include one or more input elements 310 and output elements 320 for communicating with other devices via a network. The computer 300 also includes a user interface that enables user interaction with the computer 300. The user interface may include I/O devices (e.g., keyboard, mouse, speakers, buttons, etc.) to allow the user to interact with the computer. Such input/output devices may be used in conjunction with a set of computer programs as an annotation tool to annotate images in accordance with embodiments described herein. The user interface also includes a display for displaying images and spatial realism maps to the user.

According to various embodiments, FIG. 3 is a high-level representation of possible components of a computer for illustrative purposes and the computer may contain other components. Also, the computer 300 is illustrated as a single device or system. However, the computer 300 may be implemented as more than one device or system and, in some forms, may be a distributed system with components or functions suitably distributed in, for example, a network or in various locations.

As noted above, in a more specific example of the presently described embodiments, FIGS. 4-6 will be referenced to describe an application of the presently described embodiments of image segmentation relating to identification of cancer lesions. As an example, according to the presently described embodiments, at least in one form, a technique to use ultrasound and multi-frequency opto-acoustic features is implemented to perform tumor segmentation in a way that retains the ability to use pretrained networks, especially for the isolated ultrasound component for which pretrained networks exist. Combining traditional ultrasound and opto-acoustic features results in better localization and improved classification while exploiting pretrained networks such as Resnet-50 to get better performance with less training data.

In one form, the presently described embodiments combine traditional ultrasound (US) and two channels of opto-acoustic response (OA1) and (OA2) corresponding to oxygenated and deoxygenated blood. The technique is related to the UNet segmentation network 400, an example of which is illustrated in FIG. 4. The UNet segmentation network 400 takes an image 410 as input and then outputs a second image 490 that is a transformation of the input image. A common task for UNet segmentation networks is semantic segmentation in which the UNet segmentation network is trained to output a new image where each pixel color corresponds to a specific semantic class. For example, all pixels corresponding to dogs in the original image are rendered in the color pink in the generated image, people are rendered in blue, trees are rendered in red, etc.

To further explain, the UNet segmentation network 400 does this by first abstracting the image stage by stage from a detailed but shallow representation to a deep but coarse representation that encodes many features describing the content or composition of the image. This is illustrated by the left side of the network 400 and is the encoder which produces features from an image. To accelerate learning, a pretrained network is often used for the encoder—such as Resnet-50 trained on MS-COCO or Imagenet.

The output is produced by a decoder. As shown on the right side of the network 400, the decoder combines the high-level abstract features with some details of the earlier layers to produce an output image such as image/data 490 that is based on abstractions but uses earlier levels to get the localization correct in the final output image. To carry the previous “dog” example forward, the abstract layer encodes that there is a dog-like object in the center of the image and earlier layers are used to obtain sharper boundaries of the dog. The use of multiple layers also provides some natural invariance to scale. Variations of the basic idea of the UNet segmentation network 400 can be created by changing the decoder (e.g., DeeplabV3++). It will be appreciated that changing the decoder may necessitate changes in or to the encoder.

In the cancer segmentation application, it should be appreciated that the presently described embodiments, in at least one form, identify different types of tissue that are imaged with a variety of disparate sources. Different pixel colors are used to correspond to background tissue (not a lesion), benign tissue and malignant cancerous tissue.

According to the presently described embodiments, it is recognized that the optoacoustic and ultrasound features are typically very different in nature. For example, ultrasound features show tissue boundaries well whereas optoacoustic show diffuse patterns of hemoglobin and oxygenation. Also, radiologists in the field have indicated there is more information in the ratios of optoacoustic oxy and deoxy channels than in their absolute values. It, therefore, makes sense to abstract these features before combining them. This is especially true if we want to take advantage of pretraining. This motivates the idea of a multi-stream network such as the Temporal Segment Network used in activity recognition which combines RGB color information with optical flow information. At the same time, it is important to the U-Net to maintain features at multiple scales.

To address the above noted issues for cancer lesions and other applications having disparate sources and/or differing image features, the presently described embodiments implement features and/or techniques that take the place of traditional features in, for example, a U-Net encoder, such as the encoder described in FIG. 4. In this regard, with reference to FIG. 5, given the desire to use pretrained networks, late fusion and maintain multiple scales, the presently described embodiments implement, in one form, a diffuse multi-stream architecture 500. It should be appreciated that this is not entirely a late fusion approach as fusion is done at each level of abstraction (see FIG. 5). Through the projection layer, the decoder can influence how much fusion is done each level of abstraction during back propagation training. It is, therefore, a blend of early and late fusion where the blend is determined by training on a dataset. It is a late fusion in at least the sense that features can propagate up the abstraction layers without influence of the other modalities. As shown, a three (3) channel image 510 is received. In the example shown, one channel is an ultra-sound channel while two (2) other channels originate with opto-acoustic elements of the system. The image date is split into three streams (at 520) and encoded on a stage-by-stage basis (at 530). The encoding can be accomplished in a variety of manners; however, in at least one form, the encoder makes use of convolutional neural network layers to abstract the image stage by stage from a detailed but shallow representation to a deep but coarse representation. As will be appreciated, this encodes many features describing the content or composition of the image. At each stage of the encoder, the features across the encoders are concatenated (at 540) and a single layer of non-linear units is used to encode a new feature array 550 that is an active combination of the features from the three streams. These combined features take the place of the traditional features in a U-Net encoder and provide the opportunity for the network to take advantage of fusion of relevant channels at whichever level of abstraction most improves segmentation and classification. Also, for example, in at least one form, the feature array 550 can be decoded to produce a semantic segmentation mask using any of a variety of decoding systems including, but not limited to, a Deep Lab decoder, a U-Net system, or others that will be apparent to those skilled in the art implementing the presently described embodiments. Again, it will be appreciated that changing the decoder may necessitate changes in or to the encoder.

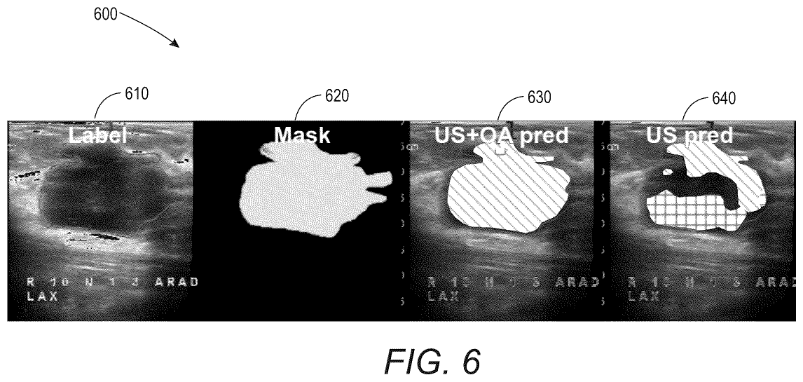

With reference to FIG. 6, results show that the combination of ultrasound and optoacoustic features yields a more consistent color mask than ultrasound features alone for certain difficult cases. Image 610 illustrates the original image with a label. Image 620 illustrates the mask which is a ground truth label from the radiologist. Image 630 is a segmentation mask, i.e., an output of an appropriate decoding process, and shows the resulting image of a combination of ultrasound and optoacoustic features according to the presently described embodiments. In this example, entire tumor region is overwhelmingly detected as a single class indicated by the diagonal hash region. And, image 640 shows a result using only ultrasound features showing that ultrasound only features are unable to find a consistent class for the whole image as indicated by the disjoint collection of diagonal and square grid hash regions on a subset of the tumor region.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for improved semantic segmentation in images comprising:
receiving image data from multiple channels corresponding to disparate input sources;
splitting the image data into data streams;
encoding the data streams using separate encoders to obtain encoded data at each stage of the separate encoders;
concatenating the encoded data across each stage of the separate encoders;
encoding the concatenated data for each stage of the encoders using a single layer of non-linear units to obtain a feature array; and, outputting the feature array.

2. The method as set forth in claim 1 wherein the disparate input sources comprise ultrasound and opto-acoustic input sources.

3. The method as set forth in claim 1 wherein the disparate input sources comprise input sources using different sensors on different bands.

4. The method as set forth in claim 1 further comprising use of pretrained networks to accelerate learning.

5. The method as forth in claim 1 further comprising decoding the feature array.

6. The method as set forth in claim 1 wherein the images include images of cancer lesions.

7. The method as set forth in claim 1, wherein the images include satellite images.

8. A system for improved semantic segmentation in images comprising:
at least one processor; and,
at least one memory, having stored therein instructions,
the memory and instructions being configured such that execution of the instructions by the processor cause the system to-
receive image data from multiple channels corresponding to disparate input sources,
split the image data into data streams,
encode the data streams using separate encoders to obtain encoded data at each stage of the separate encoders,
concatenate the encoded data across each stage of the separate encoders,
encode the concatenated data for each stage of the encoders using a single layer of non-linear units to obtain a feature array, and
output the feature array.

9. The system as set forth in claim 8 wherein the disparate input sources comprise ultrasound and opto-acoustic input sources.

10. The system as set forth in claim 8 wherein the disparate input sources comprise input sources using different sensors on different bands.

11. The system as set forth in claim 8 wherein the memory and instructions are further configured such that execution of the instructions by the processor cause the system to use pretrained networks to accelerate learning.

12. The system as forth in claim 8 wherein the memory and instructions are further configured such that execution of the instructions by the processor cause the system to decode the feature array.

13. The system as set forth in claim 8 wherein the images include images of cancer lesions.

14. The system as set forth in claim 8 wherein the images include satellite images.
